(19) United States
(12) Patent Application Publication
(10) Pub. No.: US 2022/0371443 A1
(43) Pub. Date: Nov. 24, 2022

(54) ELECTRIC VEHICLE (EV) EXTERNAL POWER PORT DEVICE, SYSTEM, AND VEHICLE WITH POWER PORT DEVICE

(71) Applicant: THE NOCO COMPANY, Glenwillow, OH (US)

(72) Inventors: James Richard STANFIELD, Glendale, AZ (US); Bruce Clark MOORE, Glendale, AZ (US)

(73) Assignee: THE NOCO COMPANY, Glenwillow, OH (US)

(21) Appl. No.: 17/755,496

(22) PCT Filed: Nov. 2, 2020
(86) PCT No.: PCT/US2020/058485

§ 371 Date: Apr. 29, 2022

Related U.S. Application Data
(60) Provisional application No. 62/930,672, filed on Nov. 5, 2019.

(51) Int. Cl. B60L 1/00; H01R 25/00; B60L 53/16; B60L 53/22

(52) U.S. Cl. CPC B60L 1/006; H01R 25/006; B60L 53/16; B60L 53/22

(57) ABSTRACT

A vehicle power port device for use with a vehicle having a rechargeable lithium ion battery, the device including one or more power ports installed in, on, or within the vehicle, the one or more power ports configured to connect to and power an electrical device or equipment located external to the vehicle and a power cable connecting the rechargeable lithium ion battery directly, or indirectly, to the one or more power ports.

### FIELD

The present invention is directed to an electric vehicle (EV) external power port, for example, an electric vehicle (EV) power port for use with an electric vehicle (EV) configured for supplying electrical power to electrical apparatus, devices, equipment, tools or otherwise to other power applications located externally relative to the electric vehicle (EV), an electric vehicle (EV) external power port system, and a vehicle (e.g. EV) having one or more power ports.

### BACKGROUND

Fully electric vehicles (EVs) are growing in popularity. Fully EV trucks are in development and soon will be available to buyers. Energy density in lithium ion batteries is rapidly improving. Batteries that can provide 1000 mile range or more will likely be made available in the coming years. This extra capacity can be applied to more than just driving miles. There will be many times that the owner of the vehicle is only using a small portion of their vehicle battery capacity for driving. The unused battery capacity could be used for other external power needs such as camping power, construction site power, RV power, home backup power, boat power, mobile power, mobile repair power, jump starting a vehicle, power to charge EV with depleted or discharged battery just to mention a few applications.

An external power port could provide external DC power, or convert the internal DC EV Power (e.g. DC power supplied by EV battery) to several usable power ports such as 110 VAC, 220 VAC, 12 VDC, 24 VDC, USB Output Ports, customized power supply. The external DC power could be used, for example, to charge one vehicle by another vehicle with the same type of battery system. This avoids going from 400 VDC>220 VDC>400 VDC, and could provide a much more efficient energy transfer vehicle-to-vehicle. Another application can be charging between EVs having different battery architecture, for example, to go from 400 VDC>800 VDC with a two times (2×) boost. The power supplied can be conditioned for overvoltage, undervoltage, overcurrent, overtemperature, etc.

For example, consider the application of powering a recreation vehicle (RV) or RV trailer when it has no access to hookups. RV hookups have a provision for 30 amp or 50 amp service. This translates to 3600 W (120V×30 A), or 6000 W (120V×50 A). Assuming the RV is using 75% of available power in a 30 A system, this would be 75% of 3600 W or 2.7 KW. If used for an hour that would be 2.7 KWh. If this energy is used for 4 hrs a day, that calculates to 10.8 KWh per day.

As another application, presently, many construction sites are run by gas or diesel generators. A common Honda generator is the 3 KW model. If this energy is used for 8 hrs at 75% load on the 3 KW generator, that calculates to 0.75×3 KW=2.25 KW×8 Hrs=18 KWh per day.

As a further application, the EV external power port can provide backup power for homes. This power can be converted to be the same specifications as power generated by a home solar power system. The home could then use the converted power supplied by the EV for temporary energy supply into the solar power system. Specifically, the power from the EV can be directly supplied to the electrical system of the solar power system of the home.

An example of the amount of energy stored by an EV, the Tesla truck is reportedly going to have 600 mile range. It is estimated that the battery will be approximately 140 KWh in size. If the truck is used for construction and the driver only drives 50 miles to the job site, this leaves 550 mile reserve range on the battery. If you just allow a 300 mile reserve range on the battery to be used for the EV external power port that calculates to be: 140 KWh/600 miles=0.23 KWh/mile×300 miles=70 KWh.

Another possible application, using a power inverter provided on board the EV, is to take solar panel DC voltage out and charge a vehicle with this power.

The examples above show various types of applications and the amount of energy that can be available and supplied for various powering applications using the EV external power port according to the present invention.

### SUMMARY

The present invention is directed to an EV power port (e.g. EV external power port) connected to, installed on, part of, or otherwise associated with or integrated into an electric vehicle (EV), and configured to provide one or more power outputs (e.g. one or more power output ports, power supply connections, power connections). The EV power port, for example, can also be configured to provide one or more power inputs (e.g. charging port for charging EV battery, power port for powering accessories of the EV). Alternatively, a vehicle power port (e.g. external power port and/or internal power port) is connected to, installed on, part of, or otherwise associated with or integrated into a hybrid vehicle or internal combustion vehicle fitted with a rechargeable lithium ion battery disposed within or installed into such a vehicle.

The EV power port or power port, for example, can be installed or assembled with the vehicle during manufacturing of the vehicle as an OEM part or accessory, or can be added to vehicle, for example, as an after-market part.

The EV power port, for example, can be configured to be accessible or located on or adjacent to the exterior of the EV (e.g. electrical connection exposed on exterior of vehicle or located underneath an exterior hatch configured to open and close). Alternatively, or in addition, the EV power port can be configured to be accessible or located in the interior of the vehicle (e.g. passenger compartment, storage compartment, customized panel or compartment for EV power port, panel located on dash board, panel or box located under dash board, panel or port located in or on a center console, panel or port located in or on one or more door panels, panel or port located on one or more seats, panel or port located on passenger compartment ceiling, panel or port located one or more roof support posts, panel or port located on seat belt assembly, panel or port or box located in glove compartment, and other locations or areas within the interior of the EV.

The EV power port, for example, can comprise a power panel, box, accessory, power output cable with power panel or power box, power track, power conversion electronics electrically connected to the EV battery (e.g. EV power port connected to EV battery by power cable(s), wiring, electrical connector(s), conductive bar(s), conductive frame(s), and/or conductive bus(es) to electrically connect to the EV battery). For example, the power panel can be provided with one or more power outputs (e.g. power connections or ports), controls, displays (e.g. GUI), sensors, electronics, one or more DC to DC converters, one or more DC to AC converters, one or more controls, one or more microcontroller, one or more circuit boards, a power surge protector, electronics for remote control operation, one or more power storage devices (e.g. one or more batteries, one or more rechargeable battery packs, one or more Li ion batteries, one or more storage capacitors, GPS, GPS port, audio in/out port(s), video in/out port(s), LAN in/out port(s), cable port(s), and other standard or customize power and/or communication ports. Alternatively, or in addition, the EV power port can be a power cable with a module (e.g. control module) having one or more power ports for transferring power out and/or into the EV.

The EV power port, for example, can be a single port situated at one location on or in the EV, or multiple ports located at different locations on or in the EV. For example, the multiple ports can have different purposes or applications and/or can be networked together in various manners (e.g. power wire harness or power conductive frame connecting together multiple ports to EV battery). A basic EV power port, for example, can have one or more output power ports and/or one or more input power ports. The EV power port, for example, can be a standard EV charging port modified to allow transferring power out of the EV, or can be a separate EV power port configured to connect or couple with a standard EV charging port and allow transferring power out (external) of the EV. Further, the EV power port can be installed in the EV so that the EV power port connects directly to the EV battery.

The EV power port can be located in one or several places. In a vehicle (e.g. passenger vehicle, pickup truck), the EV power port can be located on the back section of the vehicle by the bumper (e.g. behind hinged license plate bracket), on the front fenders, doors, or rear quarter panels (e.g. exposed port or located being hinged access panel), or located on the cab. Another possible location is next to or part of the EV charging port or otherwise integrated into the EV charging port. Again, the EV charging port itself can be modified to allow for the EV external power port (e.g. combined EV charging port and EV external power port).

The EV power port can comprise one or more electrical converters (e.g. DC to DC converter, DC/AC converter, and AC/DC converter) to allow the EV power port to be utilized in various manners and applications. For example, the converters can be configured for converting the power stored in the EV battery for use in the outside world. This usable power, for example, can be 110 VAC, 220 VAC, 12 VDC, 12 VDC, and smaller conversions like USB ports.

The energy for the EV power port can be regulated. The voltage and current specifications are configured to protect the EV battery as well as providing the optimum power for converting to be used externally of the EV.

The EV power port can include short circuit detector configured to disable power delivery if a short is detected.

The EV power port will be controlled by a secure enable to prevent power from being available to the physical port accidentally. The enable will include a sophisticated network handshaking profile that only enables it to supply power only when plugged into an approved converter.

The EV power port can have a programmable energy limit. This energy limit will can be programmable, for example, in the EV itself, and will not allow energy to exceed this limit. This will act like a “fuel gauge” and the EV will communicate the status to the converter(s) of the EV power port to allow for status updates to the user.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is installed on the one or more power panels.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is installed on the one or more power panels, and further comprising one or more housings, wherein the one or more power panels is installed within the one or more housings.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, wherein the one or more power ports is multiple power ports installed at different locations on the vehicle.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is configured to connect to an external EV charger for internally charging the rechargeable lithium ion battery.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is installed on the one or more power panels, and further comprising one or more housings, wherein the one or more power panels is installed within the one or more housings, and wherein the one or more housings comprises a sliding access door or a hinged access door.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is installed on the one or more power panels, and further comprising one or more housings, wherein the one or more power panels is installed within the one or more housings, wherein the one or more housings comprises a sliding access door or a hinged access door, and wherein the access door is provided with a latch for securing the access door in a closed position.

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is installed on the one or more power panels, and further comprising one or more housings, wherein the vehicle is an electric vehicle (EV).

The presently described subject matter is directed to a vehicle power port device for use with a vehicle have a rechargeable lithium ion battery, the device comprising or consisting of one or more power ports installed in, on, or within the vehicle, the one or more power ports configured to connect to and power an electrical device or equipment located external to the vehicle; and a power cable connecting the rechargeable lithium ion battery directly, or indirectly, to the one or more power ports, further comprising one or more power panels, wherein the one or more power ports is installed on the one or more power panels, and further comprising one or more housings, wherein the rechargeable lithium ion battery is configured for powering a drive of the vehicle.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports, wherein the system comprises multiple power ports installed at different locations on the vehicle.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports, further comprising a DC to DC converter located between the rechargeable lithium ion battery and the one or more power ports.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports, further comprising a DC to AC converter located between the rechargeable lithium ion battery and the one or more power ports.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports, further comprising a DC to DC converter located between the rechargeable lithium ion battery and the one or more power ports, and further comprising a DC to AC converter located between the rechargeable lithium ion battery and the one or more power ports.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports, further comprising a control module for controlling power supplied by the rechargeable lithium ion battery to the one or more power ports.

The presently described subject matter is directed to a vehicle power port system for use with a vehicle, the system comprising or consisting of a rechargeable lithium ion battery; one or more power ports installed in, on, or within the vehicle, the power port configured to connect to and power an electrical device or equipment located external to the vehicle; and a power cable connecting the rechargeable lithium ion battery directly, or indirectly, to the one or more power ports, wherein the vehicle is an electric vehicle (EV).

The presently described subject matter is directed to a vehicle, comprising or consisting of a body; a drive connected to or associated with the body; a rechargeable lithium ion battery; and one or more power ports electrically connected to the rechargeable lithium ion battery, the one or more power ports configured to connect to and power an electrical device or equipment located external to the vehicle.

The presently described subject matter is directed to a vehicle, comprising or consisting of a body; a drive connected to or associated with the body; a rechargeable lithium ion battery; and one or more power ports electrically connected to the rechargeable lithium ion battery, the one or more power ports configured to connect to and power an electrical device or equipment located external to the vehicle, wherein the drive comprises one or more electrical drive motors connected to the rechargeable lithium ion battery.

The presently described subject matter is directed to a vehicle, comprising or consisting of a body; a drive connected to or associated with the body; a rechargeable lithium ion battery; and one or more power ports electrically connected to the rechargeable lithium ion battery, the one or more power ports configured to connect to and power an electrical device or equipment located external to the vehicle, wherein the drive comprises one or more electrical drive motors connected to the rechargeable lithium ion battery and one or more internal combustion engines.

The presently described subject matter is directed to a vehicle, comprising or consisting of a body; a drive connected to or associated with the body; a rechargeable lithium ion battery; and one or more power ports electrically connected to the rechargeable lithium ion battery, the one or more power ports configured to connect to and power an electrical device or equipment located external to the vehicle, wherein the drive comprises one or more internal combustion engines.

### BRIEF DESCRIPTION OF DRAWINGS

FIG. 1 is a side elevational view of an electric vehicle (EV) provided with multiple EV power ports.

FIG. 2 is a front perspective view of the EV shown in FIG. 1.

FIG. 3 is a rear perspective view of the EV shown in FIG. 1.

FIG. 4 is front view of an EV power port panel according to the present invention.

FIG. 5 is a perspective view an EV power port incorporating the EV power port panel shown in FIG. 4.

FIG. 6 is a schematic diagram of the EV power ports shown installed on the EV shown in FIG. 1.

### DETAILED DESCRIPTION

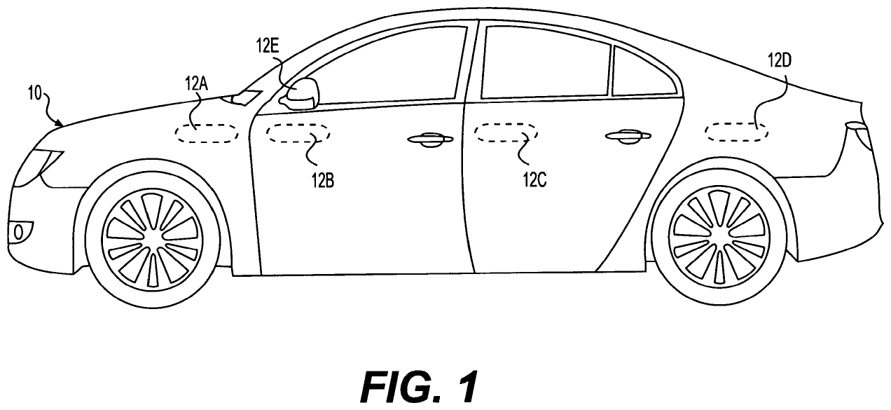

An electric vehicle (EV) 10 having one or more EV power ports 12A-E (e.g. single or multiple EV power ports) is shown in FIGS. 1-3.

The one or more EV power ports according to the present invention can be installed and used in, on, and/or within an electric vehicle (EV) having a rechargeable battery (e.g. lithium ion battery) for powering the drive of the vehicle, or installed and used in, on and/or within a hybrid vehicle having both a rechargeable battery (e.g. lithium ion battery) for powering the drive of the vehicle and an internal combustion engine for recharging the rechargeable battery. The EV and the hybrid vehicle are particularly suitable for using the one or more EV power ports, since these types of vehicles already have a large power storage capacity rechargeable battery installed for driving these types of vehicles.

In addition, other types of powered vehicles (e.g. using fuel, gasoline, diesel, gas, methane, propane, butane, hydrogen cells, capacitors, and other types of power) can be fitted or equipped with a large power storage capacity rechargeable battery and/or capacitor along with one or more EV power ports according to the present invention. Further, these types of vehicles can be fitted or equipped with charging equipment (e.g. alternator, generator, or types of charging equipment) configured to charge the large power storage capacity rechargeable battery and/or capacitor. Alternatively, or in addition, the large power storage capacity rechargeable battery and/or capacitor can be charged using an external charger (e.g. EV charger, high speed EV charger), for example, connected to one of the one or more EV power ports according to the present invention.

As shown in FIG. 1, the EV power port 12A is located in, on and/or within the front fender of the EV 10, the EV power port 12B is located in, on, and/or within the front door of the EV 10, the EV power port 12C is located in, on, and/or within the rear door of the EV 10, the EV power port 12D is located in, on, and/or within the rear fender of the EV 10, and/or the EV power port 12E is located in, on, and/or within the side mirror of the EV.

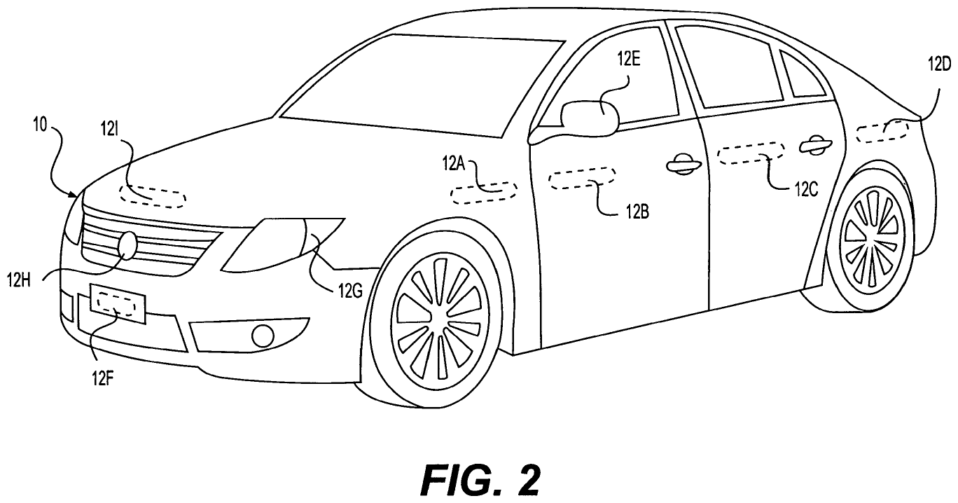

As shown in FIG. 2, the EV power port 12F is located in, on, within and/or behind the vehicle front license plate bracket (e.g. located in front bumper) of the EV 10, the EV power port 12G is located in, on, within and/or behind the front headlight assembly (e.g. front headlight is hinged or slides to open and close) of the EV 10, the power port 12H is located in, on, within, and/or behind the front plague or badge (e.g. located on front grill) of the EV 10, and/or the power port 12I is located in, on, within, and/or under the front hood of the EV 10.

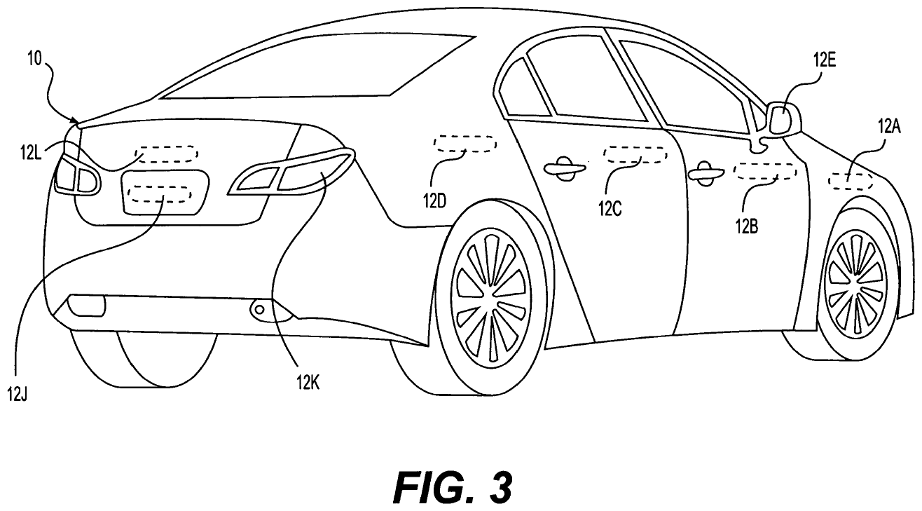

As shown in FIG. 3, the EV power port 12J is located in, on, within and/or behind the vehicle rear license plate bracket (e.g. located in rear bumper) of the EV 10, the EV power port 12K is located in, on, within, and/or behind the rear headlight assembly (e.g. rear headlight is hinged or slides to open and close) of the EV 10, and/or the EV power port 12L is located in, on, within, and/or under the rear hood of the EV 10.

Alternatively, or in addition, one or more EV power ports can be located in the passenger compartment of the EV 10. For example, an EV power port can be located in the steering wheel, steering wheel column, steering wheel hub, dash board, below dash board, floor, side window post, door panel, head liner, rear deck, seat, console, center console, gauge, radio, computer, computer screen, and/or other locations within the interior passenger compartment of the EV 10.

Alternatively, or in addition, one or more EV power ports can be located within a front compartment located under the front hood of the EV 10 and/or within a rear compartment located under the rear hood of the EV 10. In the case of and EV with a rear hatch back door, the EV power port can be located in, on, or within the rear hatch back door.

The EV power port can also be incorporate into other vehicles such as an EV truck, EV delivery van, EV motorcycle, EV mower, EV watercraft, EV boat, EV aircraft, or other EV vehicles that now exist or exist in the future.

The EV power port should be located on the EV 10 at a location easily accessible by the user. Further, a standard height location (e.g. from driving surface) can be set to standardize use for users. Further, the EV power port can be provided with a symbol or insignia to designate the accessory as an EV power port for convenience and safety (e.g. labeled, etched, tag, hologram, bar code, color, design).

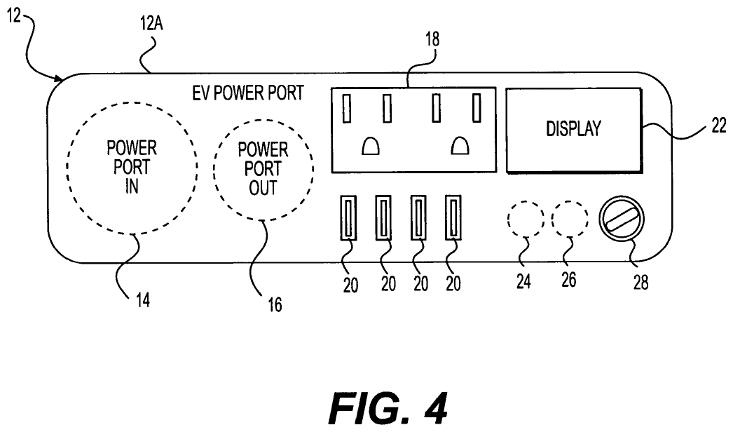

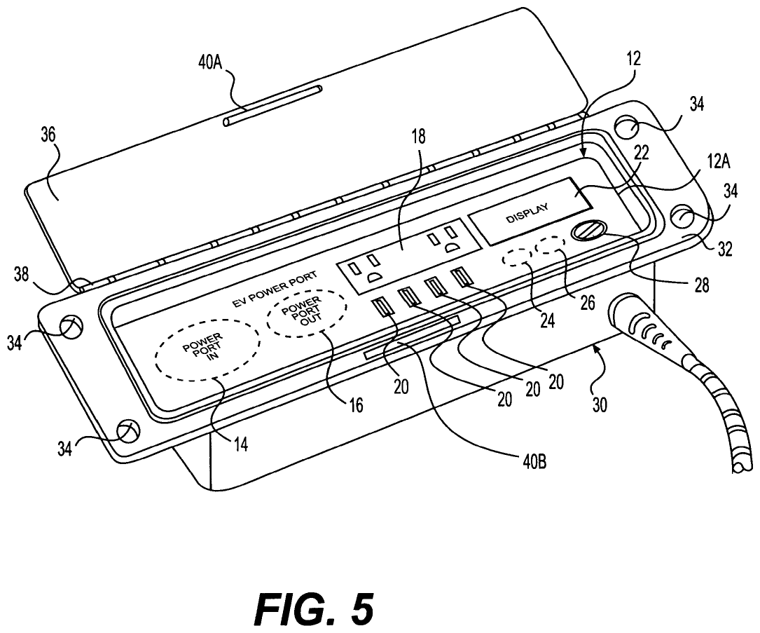

An EV power port 10 having a panel 12 according to the present invention is shown in FIGS. 4 and 5.

As shown in FIG. 4, the EV power port panel 12 comprises a panel 12A having a POWER PORT IN 14 and a POWER PORT OUT 16, two (2) NC three-prong power receptacles 18, four (4) USB power connectors 20, a visual display 22 (e.g. GUI), additional power ports 24, 26, and a control 28 having a control knob to be rotated to a selected position (e.g. to select 12V or 24V operation, control particular screen or view shown on display 22, control off/on of EV power port 10, and/or control off/on of power ports 14, 16, 24, and 26). The internal electronic of the EV power port 10 (e.g. printed circuit board(s) (PCB), microcontroller, sensors, power connectors or connections, chips, rechargeable battery, communications, display controller, audio controller, video controller, remote controller) can be located within the housing 30 beneath the EV power port panel 12.

The POWER PORT IN 14 can be a standard or custom EV receptacle configured to connect to an EV connector. The POWER PORT OUT 14 can be a standard or custom EV receptacle configured to connect to a standard or custom AC and/or DC power connector (e.g. power cable assembly with AC and/or DC power connector). Alternatively, the POWER PORT IN 14 can be replaced with another POWER PORT OUT (e.g. different size and/or configuration POWER PORT OUT) resulting in an EV power port having only power out type ports or connections (i.e. no POWER PORT IN).

As shown in FIG. 5, the EV power port 10 comprises a housing 30. The EV power port panel 12 is installed within the housing 30. The housing 30 comprises a flange 32 having four (4) through holes 34 for connection with fasteners to the EV 10 (e.g. four (4) threaded posts connected to parts or components of the EV 10 along with securing nuts).

The housing 30 further comprises an access door 36 connected to the housing 30 by a hinge 38. The housing 30 is provided with a seal 32A (e.g. rectangular-shaped O-ring seal adhered or mechanically fastened to the flange 32) so that the inner surface of the access door 36 contacts with the seal when moved into a closed position. A door latch 40A, 40B (e.g. magnetic latch) can be provided to retain the access door 36 in a closed position. The hinge 38 can be configured to resist hinge movement (e.g. having interference fit with parts) so that the access door remains in the position opened or closed when moved to the particular position by the user's fingers.

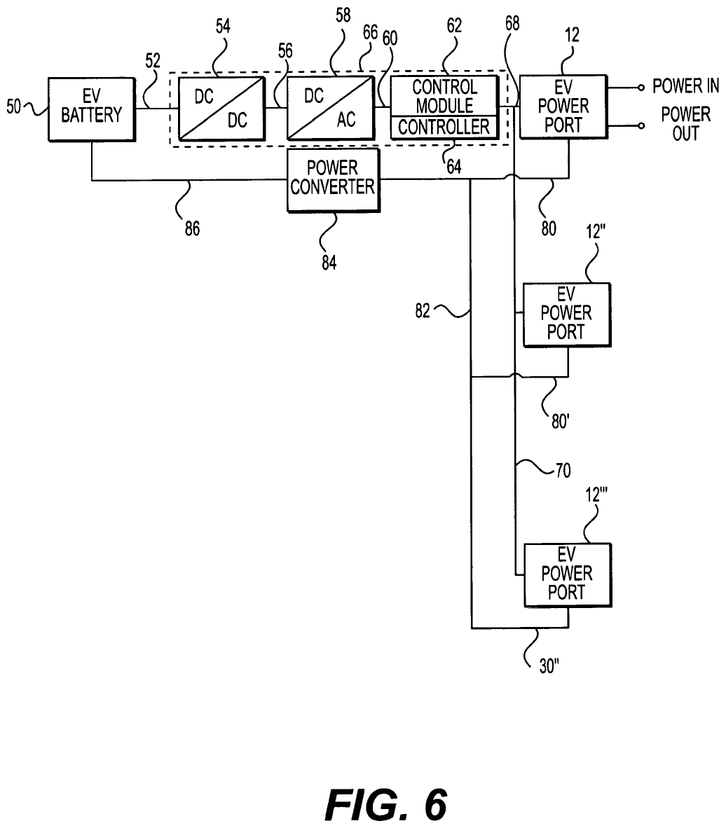

A power cable 42 is provided at one end with a stress relief 42A connected to the housing 30 to bring power from the EV battery 50 (FIG. 6) into the housing 30 of the EV power port. Specifically, an opposite end of the power cable 42 is connected directly or indirectly to the EV battery 50. For example, a power converter 84 (FIG. 6) is provided between the EV battery 50 and the one or more EV power ports 12.

The one or more EV power ports can include, or be connected, to other electrical components, in the system, as shown in FIG. 6.

For example, one or more EV power ports 12, 12′, 12″ can be connected to an EV battery 50. The EV battery 50, for example, is a high power capacity rechargeable battery configured to storing sufficient energy to drive the EV a significant distance. The one or more EV power ports 12, 12′, 12″ can be selectively operated, or can be simultaneously operated in combination one or more additional EV power ports at the same time.

A number of electronic components can be connected between the EV battery 50 and the one or more EV power ports 12, 12′, 12″. For example, some of the electronic components can be integrated into the EV power ports 12, 12′, 12″ themselves, or can be located within one or more boxes or containers at different locations within the EV 10.

As shown in FIG. 6, for example, a DC to DC converter 54, a DC to AC converter 58, and a control module 62 having a controller 64 (e.g. microcontroller) can be installed within a container or box 66 located at a location within the EV 10. A cable 50 connects the EV battery 50 to the container or box 66, and cable 68 connected to a bus 70 electrically connects the container or box 66 to the EV power ports 12, 12′, 12″.

The DC to DC converter, for example, can change the voltage being supplied from the EV battery 50 supplied to the EV power ports 12, 12′, 12″. The DC to AC converter 58 can change the DC power from the EV battery 50 to AC power supplied to the EV power ports 12, 12′, 12″.

A power converter 84 can be provided to modify the incoming power from the EV power ports 12, 12′, 12″ to power compatible for charging the EV battery 50.

1. A vehicle power port device for use with a vehicle having a rechargeable lithium ion battery, the device comprising:
one or more power ports installed in, on, or within the vehicle, the one or more power ports configured to connect to and power an electrical device or equipment located external to the vehicle; and
a power cable connecting the rechargeable lithium ion battery directly, or indirectly, to the one or more power ports.

2. The device according to claim 1, further comprising one or more power panels, wherein the one or more power ports is installed on the one or more power panels.

3. The device according to claim 2, further comprising one or more housings, wherein the one or more power panels is installed within the one or more housings.

4. The device according to claim 1, wherein the one or more power ports is multiple power ports installed at different locations on the vehicle.

5. The device according to claim 1, wherein the one or more power ports is configured to connect to an external EV charger for internally charging the rechargeable lithium ion battery.

6. The device according to claim 3, wherein the one or more housings comprises a sliding access door or a hinged access door.

7. The device according to claim 6, wherein the access door is provided with a latch for securing the access door in a closed position.

8. The device according to claim 1, wherein the vehicle is an electric vehicle (EV).

9. The device according to claim 1, wherein the rechargeable lithium ion battery is configured for powering a drive of the vehicle.

10. A vehicle power port system for use with a vehicle, the system comprising:
a rechargeable lithium ion battery;
one or more power ports installed in, on, or within the vehicle, the power port configured to connect to and power an electrical device or equipment located external to the vehicle; and
a power cable connecting the rechargeable lithium ion battery directly, or indirectly, to the one or more power ports.

11. The system according to claim 10, wherein the system comprises multiple power ports installed at different locations on the vehicle.

12. The device according to claim 10, further comprising a DC to DC converter located between the rechargeable lithium ion battery and the one or more power ports.

13. The device according to claim 10, further comprising a DC to AC converter located between the rechargeable lithium ion battery and the one or more power ports.

14. The device according to claim 12, further comprising a DC to AC converter located between the rechargeable lithium ion battery and the one or more power ports.

15. The device according to claim 10, further comprising a control module for controlling power supplied by the rechargeable lithium ion battery to the one or more power ports.

16. The device according to claim 10, wherein the vehicle is an electric vehicle (EV).

17. A vehicle, comprising:
a body;
a drive connected to or associated with the body;
a rechargeable lithium ion battery; and
one or more power ports electrically connected to the rechargeable lithium ion battery, the one or more power ports configured to connect to and power an electrical device or equipment located external to the vehicle.

18. The vehicle according to claim 17, wherein the drive comprises one or more electrical drive motors connected to the rechargeable lithium ion battery.

19. The vehicle according to claim 17, wherein the drive comprises one or more electrical drive motors connected to the rechargeable lithium ion battery and one or more internal combustion engines.

20. The vehicle according to claim 17, wherein the drive comprises one or more internal combustion engines.
